(19) United States
(12) Patent Application Publication
(10) Pub. No.: US 2008/0162918 A1
(43) Pub. Date: Jul. 3, 2008

(54) HIDE BOOT

(75) Inventors: Mika MUURINEN, Lempiala (FI); Mika SOMERO, Kempele (FI); Annikka AALTO, Oulu (FI); Jarmo PAAKKONEN, Jaali (FI)

Correspondence Address: PERMAN & GREEN, 425 POST ROAD, FAIRFIELD, CT, 06824, US

(73) Assignee: NOKIA CORPORATION, Espoo (FI)

(21) Appl. No.: 11/618,995

(22) Filed: Jan. 2, 2007

(51) Int. Cl. G06F 1/32; G06F 15/177

(52) U.S. Cl. 713/2

(57) ABSTRACT

A mobile apparatus is disclosed, including a processor; a volatile memory connected to the processor; a non-volatile storage connected to the processor; and an operating system executable by the processor for controlling operations of the mobile apparatus. The mobile apparatus has an off-mode, a hibernation mode, wherein any contents only are stored in the non-volatile storage, and an on-mode. The mobile apparatus further includes an event detector arranged to initiate, upon detecting the event, the processor to perform a boot operation for loading the operating system, and to enter the hibernation mode where contents of the volatile memories are stored in a low-power mode; and an on/off-key arranged to receive a user indication about switching-on/off the mobile apparatus, wherein, upon receiving the user indication, the processor is arranged to reload the contents to the volatile memories to put the mobile apparatus in an on-mode. A method for startup of such an apparatus is also disclosed.

### TECHNICAL FIELD

The disclosed embodiments relate to a method for startup operation of an apparatus, and such an apparatus.

### BACKGROUND

For many apparatuses, especially mobile apparatuses, a general consideration is power management to enable long operation time with available power of a battery and/or to enable use of a small battery which makes the weight and volume of the apparatus reasonable. Many times, a user of a mobile apparatus turns off the apparatus when possible to save power. This result in that the situation of powering up the mobile apparatus is rather common. A conventional power-up operation is therefore explained here.

A conventional apparatus can comprise an on/off key, which a user uses to turn the apparatus on or off. When turning on the apparatus, the processor starts booting, i.e. starts loading necessary program code from non-volatile memory, e.g. an operating system, into volatile memories of the apparatus, and start executing the program code. This normally takes a while before any application of the apparatus can start to execute. To speed this procedure, more powerful components may be used, i.e. processor, bus, and memories. However, this also increase both cost and power consumption, and is therefore not always desirable, especially not in portable apparatuses. Therefore, there is a need for improving startup of such apparatuses.

### SUMMARY

In view of the above, it would be advantageous to solve or at least reduce the problems discussed above. In particular, it would be advantageous to speed up experienced startup procedure of an apparatus.

The disclosed embodiments are based on the understanding that a trade-off between user experienced speed and power management will provide an advantageous effect. The general concept is that the apparatus boots in advance, and then enter a hibernation mode, i.e. a mode where loaded values and states of the volatile memories are saved in a low-power mode whereby the volatile memories and most of the circuits of the processor can be powered down to save energy. When a user indicates that the apparatus is to be turned on, the apparatus enters the on-mode from the hibernation mode, i.e. the volatile memories and the circuits of the processor are powered up and the stored values and states are treated in a normal mode in the volatile memories whereby the apparatus is up and running within a shorter time than a normal cold start.

According to a first aspect of the disclosed embodiments, there is provided a method for startup operation of a mobile apparatus, comprising detecting an event of a mobile apparatus in off-mode; upon detecting said event, performing a boot operation for loading an operating system; and entering a hibernation mode where contents of volatile memories stored in a low-power mode; and upon a user indication about switching-on the mobile apparatus, re-entering a normal mode for said contents of said volatile memories to put said mobile apparatus in an on-mode.

The low-power mode may comprise writing said contents to non-volatile storage, and re-entering to a normal mode may then comprise reloading said contents to said volatile memories.

The low-power mode may comprises low-rate refresh of said volatile memories, and re-entering to a normal mode may then comprise normal rate refresh of said volatile memories.

The event may comprise any of the group comprising: inserting a battery to said mobile apparatus, switching off the mobile apparatus, the mobile apparatus performing a reminder or alarm operation, pressing power-on key, and connecting battery charger.

The method may further comprise keeping a user interface of said mobile apparatus in an off-state while in said off-mode and hibernation mode; and switching on said user interface when entering said on-mode.

The method may further comprise determining, when in said hibernation mode, if a predetermined condition is fulfilled; and entering, when said predetermined condition is fulfilled, said off-mode.

The predetermined condition may comprise any of the group comprising: battery level being below a predetermined threshold, and hibernation mode has been present for a predetermined time.

According to a second aspect of the disclosed embodiments, there is provided a mobile apparatus comprising a processor; a volatile memory connected to said processor; a non-volatile storage connected to said processor; and an operating system executable by said processor for controlling operations of said mobile apparatus, the mobile apparatus having an off-mode, a hibernation mode, wherein any contents only are stored in said non-volatile storage, and an on-mode, the mobile apparatus further comprises an event detector arranged to initiate, upon detecting said event, said processor to perform a boot operation for loading said operating system, and to enter said hibernation mode where contents of said volatile memories are stored in a low-power mode; and an on/off-key arranged to receive a user indication about switching-on/off the mobile apparatus, wherein, upon receiving said user indication, the processor is arranged to re-enter a normal mode for said contents of said volatile memories to put said mobile apparatus in an on-mode.

In said low-power mode, said contents may be stored in said non-volatile storage, and, in said normal mode, said contents may be re-loaded into said volatile memories. Alternatively, in said low-power mode, said volatile memories may be arranged for low-rate refresh, and, upon re-entering to a normal mode, said volatile memories may be arranged for normal rate refresh.

The event may comprise any of the group comprising: inserting a battery to said mobile apparatus, switching off the mobile apparatus, the mobile apparatus performing a reminder or alarm operation, pressing power-on key, and connecting battery charger.

The mobile apparatus may further comprise a user interface arranged to be in an off-state while said mobile apparatus is in said off-mode and hibernation mode, and enabled to be in an on-state when said mobile apparatus is in said on-mode.

The processor may be arranged to determine, when in said hibernation mode, if a predetermined condition is fulfilled, and to enter, when said predetermined condition is determined to be fulfilled, said off-mode. The predetermined condition may comprise any of the group comprising: battery level being below a predetermined threshold, and hibernation mode has been present for a predetermined time.

According to a third aspect of the disclosed embodiments, there is provided a mobile communication apparatus comprising means for implementing the first aspect of the disclosed embodiments.

The mobile apparatus may be a mobile phone, a personal digital assistant, a digital camera, a media player, or a game console, or any combination thereof.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

Other features and advantages of the disclosed embodiments will appear from the following detailed disclosure, from the attached dependent claims as well as from the drawings.

### BRIEF DESCRIPTION OF THE DRAWINGS

The above, as well as additional features and advantages of the disclosed embodiments, will be better understood through the following illustrative and non-limiting detailed description of preferred embodiments, with reference to the appended drawings, where the same reference numerals will be used for similar elements, wherein:

FIG. 1 schematically illustrates an apparatus according to an embodiment; and

FIG. 2-7 are a flow charts illustrating methods according to the disclosed embodiments.

### DETAILED DESCRIPTION OF PREFERRED EMBODIMENTS

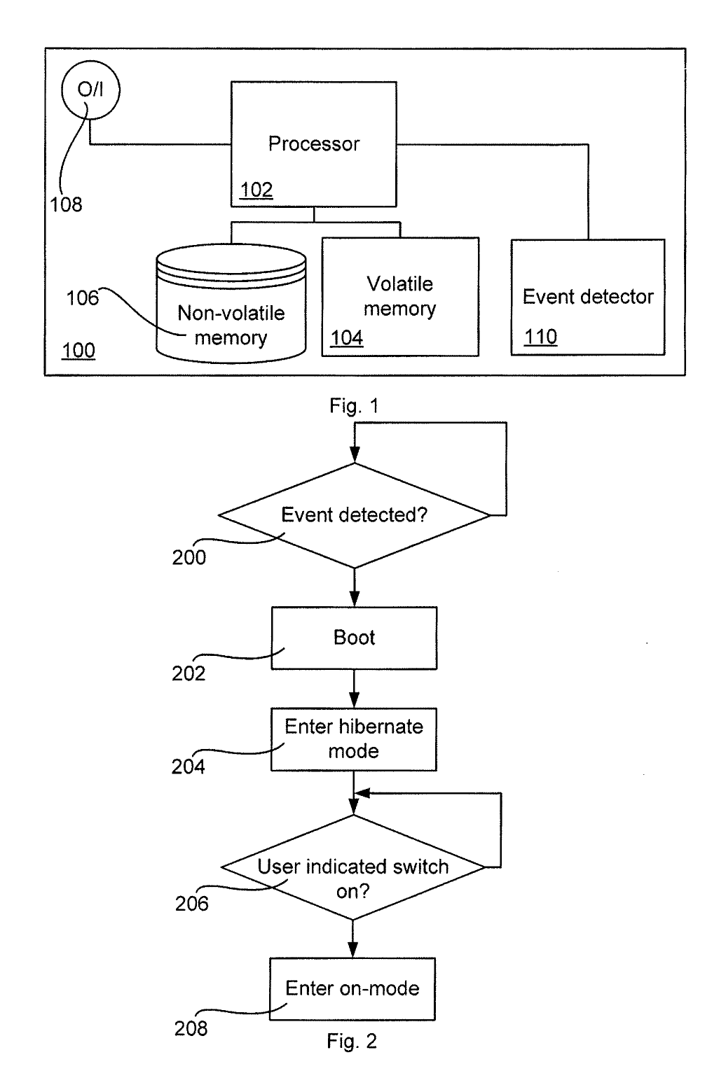

FIG. 1 schematically illustrates an apparatus 100 according to an embodiment. Elements that do not directly impact the particular effects of the disclosed embodiments have been omitted in the drawing and the disclosure below, not to obscure the particular features of the claimed invention. However, the person skilled in the art will readily understand how the claimed invention can be used in apparatuses comprising the features of the disclosed embodiments in combination with other features, such as transmitter, receiver, user interface, applications, mechanics, input and output means, etc.

The apparatus 100 comprises a processor 102 which is adapted and programmed to control operations of the apparatus 100. This adaption and programming are, among other measures, performed by utilizing an operating system (OS), which is a program for managing hardware and software resources of the apparatus 100. Among the hardware resources, there is one or more volatile memories, which can either be in the processor 102, such as registers and/or cache memory, or external to the processor, but as a part of the apparatus 102, such as random access memory (RAM), which is represented by reference numeral 104. Among the hardware resources, there is also one or more non-volatile memories, which can be a any kind of read only memory (ROM), a flash memory, a disk drive, etc. located in the apparatus 100, which non-volatile memory is represented by reference numeral 106, or a remote memory, such as in a server, being accessible by the apparatus.

The apparatus 100 is preferably a mobile apparatus comprising a battery for powering the apparatus 100. For mobile apparatuses, a general consideration is power management to enable long operation time with the available power of the battery and/or to enable use of a small battery which makes the weight and volume of the apparatus reasonable. Many times, a user of a mobile apparatus turn off the apparatus when possible to save power. This result in the situation of powering up the mobile apparatus is rather common. For the understanding of the invention, a conventional power-up operation is therefore explained here.

A conventional apparatus can comprise an on/off key, which a user uses to turn the apparatus on or off. When turning on the apparatus, the processor starts booting, i.e. starts loading necessary program code from non-volatile memory, e.g. an OS, into volatile memories of the apparatus, and start executing the program code. This normally takes a while before any application of the apparatus can start to execute. To speed this procedure, more powerful components may be used, i.e. processor, bus, and memories. However, this also increase both cost and power consumption, and is therefore not always desirable, especially not in portable apparatuses.

The disclosed embodiments are based on an advantageous trade-off between user experienced speed and power management. The general concept is that the apparatus boots in advance, and then enter a hibernation mode, i.e. contents of volatile memories are stored in a low-power mode, e.g. by low-rate refresh of volatile memories, or by letting loaded values and states of the volatile memories are saved in a non-volatile memory whereby the volatile memories and most of the circuits of the processor can be powered down to save energy. When a user indicates that the apparatus is to be turned on, the apparatus enters the on-mode from the hibernation mode, i.e. the volatile memories are refreshed at a normal rate, or the volatile memories and the circuits of the processor are powered up and the stored values and states are reloaded into the volatile memories whereby the apparatus is up and running within a shorter time than a normal cold start. The impact on power management is that the apparatus in the hibernation mode consumes slightly more power power than a complete shut-down apparatus. However, as will be discussed below, there are disclosed embodiments where the extra power consumption is limited.

Returning to FIG. 1, the apparatus 100 further comprises an event detector 110. The event detector 110 is preferably a hardware or firmware element that is enabled to be active in any mode, and especially in off-mode. The event detector 110 is arranged to detect an event when the apparatus is in off-mode that is assumed to indicate probability that a user intends to turn on the apparatus in the future, preferably a relatively close future. For example, the event that is to be detected can be inserting a battery, connection of a battery charger, movements of the apparatus 100, changes in ambient light, time of day, alarm or reminder given by the apparatus, etc. The event can also be that the user indicates that the apparatus is to be turned off, whereby the apparatus enters the hibernation mode.

FIG. 2 is a flow chart briefly illustrating a method of an embodiment. In an event detection step 200, an event, as described above, is detected. If not, the detection step 200 is looped. When the event is detected, the apparatus boots up in a boot step 202, and when booting is done, the apparatus enter a hibernation mode in a hibernation mode step 204. During these steps 200 to 204, a user interface of the apparatus, if the apparatus has one, is still inactive, or provides limited activities. In a user indication checking step 206, it is detected if the user indicates that the apparatus is to be turned on. This can for example be checking if an on/off button is pressed. This step 206 loops until such an indication is detected. Then, the apparatus enters an on-mode from the hibernation mode in an on-mode entering step 208. In the on-mode entering step 208, a user interface of the apparatus is preferably turned on.

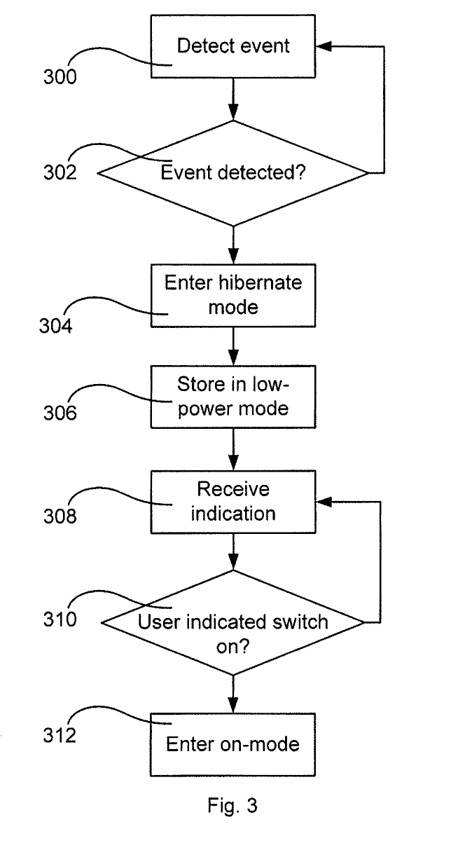

FIG. 3 is a flow chart illustrating a method according to an embodiment. An event can be detected in an event detection step 300, such that it can be checked in an event check step 302 if an event is detected. Throughout this disclosure, the term “event” should be construed to be inserting a battery to said mobile apparatus, switching off the mobile apparatus, the mobile apparatus performing a reminder or alarm operation, pressing power-on key, and connecting battery charger, in any combination or sole. If no event is detected, the event detection step 300 is re-entered. If the expected event is detected, the process continues to a hibernation mode entering step 304, and then to a low-power storing mode step 306, where contents of volatile memory or memories are stored in a low-power mode. Thus, the apparatus is in a hibernation mode. The apparatus now wait for receiving an indication in a indication reception step 308, wherein the indication is an indication from a user that the user wants to power up the apparatus. This can for example be the user pressing a power on key of the apparatus. In an indication checking step 310, it is checked if an indication is received. If no indication is received, the indication reception step 308 is re-entered. If an expected indication is received, the process continues to an on-mode entering step 312, where the apparatus is brought back to a normal on-mode again, but the user will experience a faster power up of the apparatus compared to a conventional cold start.

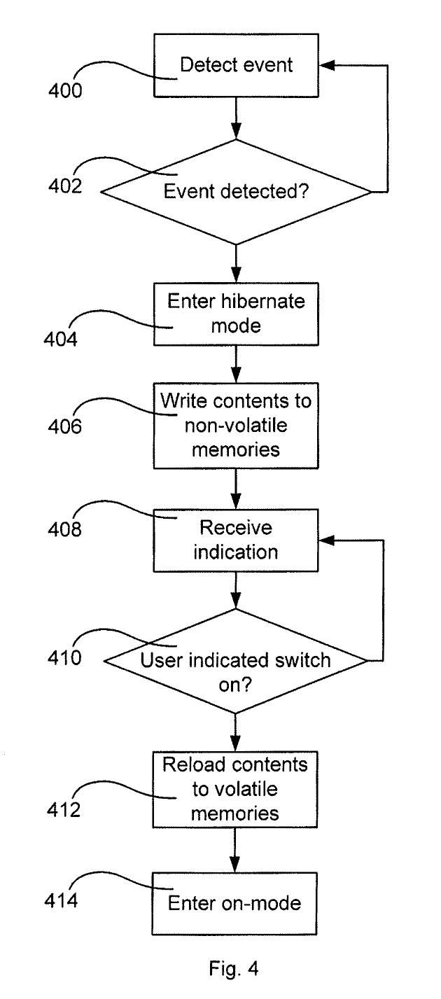

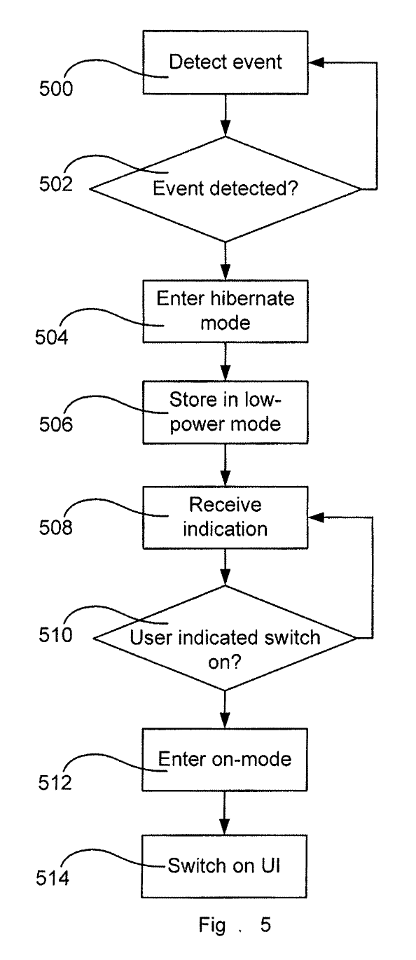

FIG. 4 is a flow chart illustrating a method according to an embodiment. An event can be detected in an event detection step 400, such that it can be checked in an event check step 402 if an event is detected. If no event is detected, the event detection step 400 is re-entered. If the expected event is detected, the process continues to a hibernation mode entering step 404, and then to a storing step 406, where contents, i.e. values and states, of volatile memory or memories are stored in non-volatile memory or memories. Thus, the apparatus is in a hibernation mode and most of its circuitry can be powered down. The apparatus now wait for receiving an indication in a indication reception step 408, wherein the indication is an indication from a user that the user wants to power up the apparatus. This can for example be the user pressing a power-on key of the apparatus. In an indication checking step 410, it is checked if an indication is received. If no indication is received, the indication reception step 408 is re-entered. If an expected indication is received, the process continues to a reloading step 412 where the contents are reloaded to the volatile memory or memories, and then an on-mode entering step 414 can be entered, where the apparatus is brought back to a normal on-mode again, but the user will experience a faster power up of the apparatus compared to a conventional cold start.

FIG. 5 is a flow chart illustrating a method according to an embodiment. An event can be detected in an event detection step 500, such that it can be checked in an event check step 502 if an event is detected. If no event is detected, the event detection step 500 is re-entered. If the expected event is detected, the process continues to a hibernation mode entering step 504, and then to a storing step 506, where the volatile memory or memories are refreshed with a considerably lower rate, thus saving power. Other circuits of the apparatus, such as processor and interface circuits can also enter a low-power mode, or be switched off. Thus, the apparatus is in a hibernation mode. The apparatus now wait for receiving an indication in a indication reception step 508, wherein the indication is an indication from a user that the user wants to power up the apparatus. This can for example be the user pressing a power-on key of the apparatus. In an indication checking step 510, it is checked if an indication is received. If no indication is received, the indication reception step 508 is re-entered. If an expected indication is received, the process continues to an on-mode entering step 512. A user interface of the apparatus has been switched off so far during the process, and is switched on in a user interface switching-on step 514. Now the apparatus is brought back to a normal on-mode, but the user will experience a faster power up of the apparatus compared to a conventional cold start. When the apparatus is in the hibernation mode, slightly more power is consumed than in off-mode. Thus, when the apparatus is not used and charged for a long time, battery level may become low. To prevent this, here will be suggested and disclosed a number of ways to limit this effect.

Battery level is often monitored. This information on the battery level can be used such that when the battery level becomes below a predetermined level, the apparatus is turned off, i.e. goes from hibernation mode to off-mode.

A clock function is often present. This can be used for monitoring for how long the apparatus has been in the hibernation mode. When the apparatus has been in a hibernation mode for a predetermined time, the apparatus is turned off.

Rules for turning off the apparatus when in the hibernation mode can be a complex set of rules, which is a combination of the above battery level and hibernation mode time criterions, and can also be combined with criterions on sensor values, time of day, etc.

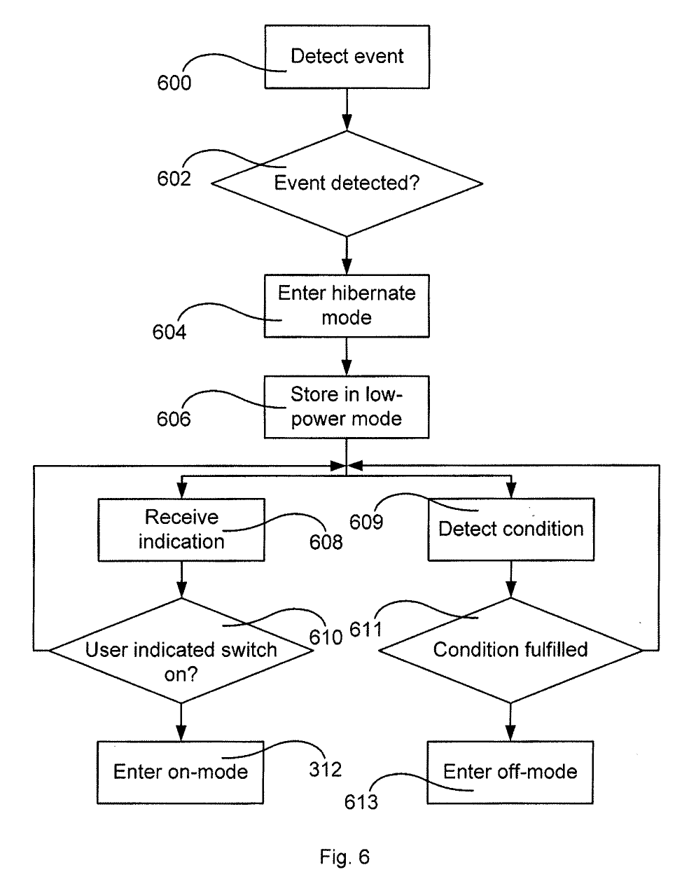

FIG. 6 is a flow chart illustrating a method according to an embodiment. An event can be detected in an event detection step 600, such that it can be checked in an event check step 602 if an event is detected. If no event is detected, the event detection step 600 is re-entered. If the expected event is detected, the process continues to a hibernation mode entering step 604, and then to a low-power storing mode step 606, where contents of volatile memory or memories are stored in a low-power mode. Thus, the apparatus is in a hibernation mode. The apparatus now wait for either receiving an indication in a indication reception step 608, wherein the indication is an indication from a user that the user wants to power up the apparatus, or detecting a predetermined condition in a condition detection step 609. The indication can for example be the user pressing a power on key of the apparatus. In an indication checking step 610, it is checked if an indication is received. If no indication is received, the process returns to waiting for either an indication or detecting a condition. Similarly, if the condition is not fulfilled in a condition checking step 611, the process returns to waiting for either an indication or detecting a condition. If an expected indication is considered to be received in the indication checking step 610, the process continues to an on-mode entering step 612, where the apparatus is brought back to a normal on-mode again, but the user will experience a faster power up of the apparatus compared to a conventional cold start. If the condition is considered to be fulfilled in the condition checking step 611, the apparatus is turned off in an off-mode entering step 613. Here, the condition can be that a battery level is below a predetermined threshold, or the hibernation mode has been present for a predetermined time, or a combination of these. The combination can be implemented as making said threshold being a function of said elapsed time in hibernation mode, or making said predetermined time be a function of said battery level. The entering of the off-mode will avoid draining the battery too much.

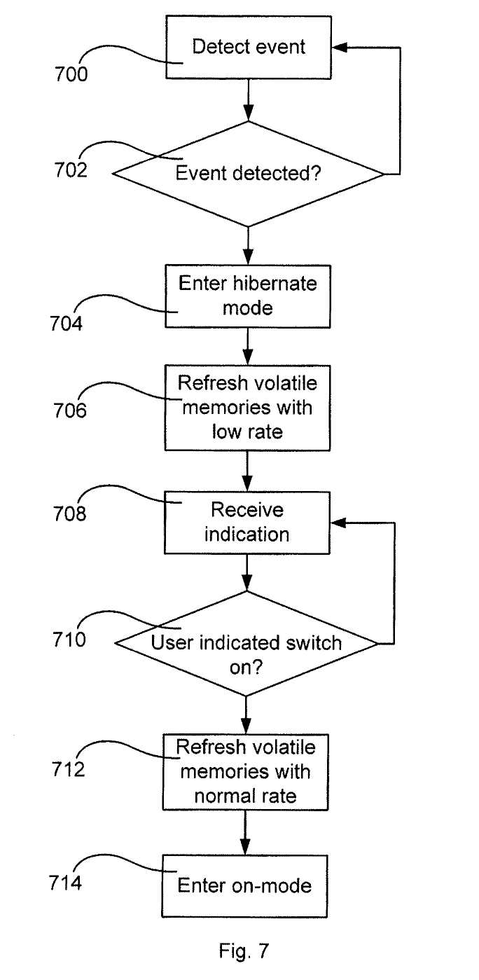

FIG. 7 is a flow chart illustrating a method according to an embodiment. An event can be detected in an event detection step 700, such that it can be checked in an event check step 702 if an event is detected. If no event is detected, the event detection step 700 is re-entered. If the expected event is detected, the process continues to a hibernation mode entering step 704, and then to a low-rate refresh entering step 706, where volatile memory or memories of the apparatus are refreshed at a condiderably lower rate. Thus, the apparatus is in a hibernation mode and a lot of its circuitry can be powered down or at least operated in low-power mode. The apparatus now wait for receiving an indication in a indication reception step 708, wherein the indication is an indication from a user that the user wants to power up the apparatus. This can for example be the user pressing a power-on key of the apparatus. In an indication checking step 710, it is checked if an indication is received. If no indication is received, the indication reception step 708 is re-entered. If an expected indication is received, the process continues to a normal rate refresh entering step 712 where the volatile memory or memories are refreshed at a normal rate, and then an on-mode entering step 714 can be entered, where the apparatus is brought back to a normal on-mode again, but the user will experience a faster power up of the apparatus compared to a conventional cold start.

The apparatus can be a mobile phone, a personal digital assistant, a digital camera, a media player, a game console, etc. The apparatus can also be an integrated combination of two or more of these apparatuses, e.g. a mobile phone with camera.

The claimed invention has mainly been described above with reference to a few embodiments. However, as is readily appreciated by a person skilled in the art, other embodiments than the ones disclosed above are equally possible within the scope of the invention, as defined by the appended patent claims.

1. A method for startup operation of a mobile apparatus, comprising
detecting an event of a mobile apparatus in off-mode;
upon detecting said event,
performing a boot operation for loading an operating system; and
entering a hibernation mode where contents of volatile memories are stored in a low-power mode; and
upon a user indication about switching-on the mobile apparatus,
re-entering a normal mode for said contents of said volatile memories to put said mobile apparatus in an on-mode.

2. The method according to claim 1, wherein said low-power mode comprises writing said contents to non-volatile storage, and re-entering to a normal mode comprises reloading said contents to said volatile memories.

3. The method according to claim 1, wherein said low-power mode comprises low-rate refresh of said volatile memories, and re-entering to a normal mode comprises normal rate refresh of said volatile memories.

4. The method according to claim 1, wherein said event comprises any of the group comprising: inserting a battery to said mobile apparatus, switching off the mobile apparatus, the mobile apparatus performing a reminder or alarm operation, pressing power-on key, and connecting battery charger.

5. The method according to claim 1, further comprising
keeping a user interface of said mobile apparatus in an off-state while in said off-mode and hibernation mode; and
switching on said user interface when entering said on-mode.

6. The method according to claim 1, further comprising
determining, when in said hibernation mode, if a predetermined condition is fulfilled; and
entering, when said predetermined condition is fulfilled, said off-mode.

7. The method according to claim 5, wherein said predetermined condition comprises any of the group comprising: battery level being below a predetermined threshold, and hibernation mode has been present for a predetermined time.

8. A mobile apparatus comprising
a processor;
a volatile memory connected to said processor;
a non-volatile storage connected to said processor; and
an operating system executable by said processor for controlling operations of said mobile apparatus,
the mobile apparatus having an off-mode, a hibernation mode, wherein any contents only are stored in said non-volatile storage, and an on-mode,
the mobile apparatus further comprises
an event detector arranged to initiate, upon detecting said event, said processor to perform a boot operation for loading said operating system, and to enter said hibernation mode where contents of said volatile memories are stored in a low-power mode; and
an on/off-key arranged to receive a user indication about switching-on/off the mobile apparatus, wherein, upon receiving said user indication, the processor is arranged to re-enter a normal mode for said contents of said volatile memories to put said mobile apparatus in an on-mode.

9. The apparatus according to claim 8, wherein, in said low-power mode, said contents are stored in said non-volatile storage, and, in said normal mode, said contents are re-loaded into said volatile memories.

10. The apparatus according to claim 8, wherein, in said low-power mode, said volatile memories are arranged for low-rate refresh, and, upon re-entering to a normal mode, said volatile memories are arranged for normal rate refresh.

11. The mobile apparatus according to claim 8, wherein said event comprises any of the group comprising: inserting a battery to said mobile apparatus, switching off the mobile apparatus, the mobile apparatus performing a reminder or alarm operation, pressing power-on key, and connecting battery charger.

12. The mobile apparatus according to claim 8, further comprising a user interface arranged to be in an off-state while said mobile apparatus is in said off-mode and hibernation mode, and enabled to be in an on-state when said mobile apparatus is in said on-mode.

13. The mobile apparatus according to claim 8, wherein said processor is arranged to determine, when in said hibernation mode, if a predetermined condition is fulfilled, and to enter, when said predetermined condition is determined to be fulfilled, said off-mode.

14. The mobile apparatus according to claim 13, wherein said predetermined condition comprises any of the group comprising: battery level being below a predetermined threshold, and hibernation mode has been present for a predetermined time.

15. The mobile apparatus according to claim 8, being a mobile phone, a personal digital assistant, a digital camera, a media player, or a game console, or any combination thereof.

16. A mobile apparatus, comprising
means for detecting an event of a mobile apparatus in off-mode;
means for performing a boot operation for loading an operating system upon detecting said event; and
means for entering a hibernation mode where contents of volatile memories are stored in a low-power mode;
means for receiving a user indication about switching-on the mobile apparatus; and
means for re-entering a normal mode for said contents of said volatile memories to put said mobile apparatus in an on-mode upon receiving said user indication.

17. The mobile apparatus according to claim 16, wherein said low-power mode involves means for writing said contents to non-volatile storage, and said means for re-entering to a normal mode comprises means for reloading said contents to said volatile memories.

18. The mobile apparatus according to claim 16, wherein said low-power mode involves means for low-rate refresh of said volatile memories, and said means for re-entering to a normal mode comprises means for normal rate refresh of said volatile memories.

19. The mobile apparatus according to claim 16, wherein said event comprises any of the group comprising: inserting a battery to said mobile apparatus, switching off the mobile apparatus, the mobile apparatus performing a reminder or alarm operation, pressing power-on key, and connecting battery charger.

20. The mobile apparatus according to claim 16, further comprising
means for controlling a user interface of said mobile apparatus to be in an off-state while in said off-mode and hibernation mode; and
means for switching on said user interface when entering said on-mode.

21. The mobile apparatus according to claim 16, further comprising
means for determining, when in said hibernation mode, if a predetermined condition is fulfilled; and
means for entering, when said predetermined condition is fulfilled, said off-mode.

22. The mobile apparatus according to claim 21, wherein said predetermined condition comprises any of the group comprising: battery level being below a predetermined threshold, and hibernation mode has been present for a predetermined time.

23. The mobile apparatus according to claim 16, being a mobile phone, a personal digital assistant, a digital camera, a media player, or a game console, or any combination thereof.
